(19) United States
(12) Patent Application Publication
(10) Pub. No.: US 2026/0054758 A1
(43) Pub. Date: Feb. 26, 2026

(54) Cooler Utility Cart Device

(71) Applicant: Gerardo Perez, Elgin, TX (US)

(72) Inventor: Gerardo Perez, Elgin, TX (US)

(21) Appl. No.: 19/300,106

(22) Filed: Aug. 14, 2025

Related U.S. Application Data
(60) Provisional application No. 63/684,893, filed on Aug. 20, 2024.

(51) Int. Cl. B62B 1/26; B62B 5/06; F25D 11/00

(52) U.S. Cl. CPC B62B 1/264; B62B 5/06; F25D 11/003

(57) ABSTRACT

A cooler utility cart device is disclosed, which is a modified utility trailer cart that is capable of transporting a large ice chest with the strength of one person. The cooler utility cart device comprises a base component that has a squared back section and triangular sides with a set of pneumatic tires and a handle. Once a cooler is fitted within the square backing, straps can be used to secure the cooler into the base component. The handle is telescopic and ergonomic and allows a user to pull the device and attached cooler along rough terrain with ease. Further, the cooler can be stabilized on the ground via placement of a prop component which attaches underneath the front of the cooler, allowing the cooler to be positioned parallel to the device.

### CROSS-REFERENCE TO RELATED APPLICATION

The present application claims priority to, and the benefit of, U.S. Provisional Application No. 63/684,893, which was filed on Aug. 20, 2024, and is incorporated herein by reference in its entirety.

### FIELD OF THE INVENTION

The present invention relates generally to the field of cooler utility cart devices. More specifically, the present invention relates to a utility cart that helps a single person independently transport large and oversized ice chests and coolers. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in cooler utility cart devices. Generally, people may own large ice chests to transport food, beverages, ice, and other items to and from various outdoor locations like the beach, campsites, tailgate areas, and more. However, it typically requires two people to carry theses large ice chests due to their size. One person trying to move the chest with items inside may struggle and end up with severe back aches and pains, if they manage to lift and carry the cooler.

Further, moving the large chest across uneven terrain can also be difficult, as the wheels on the ice chest (if any) are typically small and inadequate for moving on the rough terrain. Additionally, standard wagons and other pull carts may not be able to accommodate large ice chests due to their size and weight. Accordingly, users may have no other means for transporting large ice chests than by carrying them.

Accordingly, there is a demand for an improved cooler utility cart device that allows users to independently transport large and oversized ice chests and coolers. More particularly, there is a demand for a cooler utility cart device that allows users to fill the ice chest with food, beverages, and ice and then secure it to the device for easy transport.

Therefore, there exists a long felt need in the art for a cooler utility cart device that provides users with a utility cart that helps a single person independently transport large and oversized ice chests and coolers. There is also a long felt need in the art for a cooler utility cart device that allows users to fill the chest with food, beverages, ice, and other items and then strap it securely into the cart for transport. Further, there is a long felt need in the art for a cooler utility cart device that utilizes a pair of pneumatic wheels that facilitate movement over gravel, dirt, sand, and any other type of uneven or rough terrain. Moreover, there is a long felt need in the art for a device that maintains optimal stability via the square backing and straps to keep the ice chest secure as a user pulls the cart along the ground. Further, there is a long felt need in the art for a cooler utility cart device that offers a sleek and agile design that allows people to easily transport their ice chests to campsites, tailgate areas, lakes, ponds, pools, beaches, and numerous other outdoor areas. Finally, there is a long felt need in the art for a cooler utility cart device that can be constructed of wood, aluminum, or carbon fiber.

The subject matter disclosed and claimed herein, in one embodiment thereof, comprises a cooler utility cart device. The device is a modified utility trailer cart that is capable of transporting a large ice chest with the strength of one person. The cooler utility cart device comprises a base component that has a squared back section and triangular sides with a set of pneumatic tires and a handle. Once a cooler is fitted within the square backing, straps can be used to secure the cooler into the base component. The handle is telescopic and ergonomic and allows a user to pull the device and attached cooler along rough terrain with ease. Further, the cooler can be stabilized on the ground via placement of a prop component which attaches underneath the front of the cooler, allowing the cooler to be positioned parallel to the device.

In this manner, the cooler utility cart device of the present invention accomplishes all of the forgoing objectives and provides users with a device that allows a single person to transport large and oversized ice chests and coolers. The device is a utility cart that can secure a cooler for transport. The device can be manufactured of wood, aluminum, or carbon fiber materials.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cooler utility cart device. The device is a modified utility trailer cart that is capable of transporting a large ice chest with the strength of one person. The cooler utility cart device comprises a base component that has a squared back section and triangular sides with a set of pneumatic tires and a handle. Once a cooler is fitted within the square backing, straps can be used to secure the cooler into the base component. The handle allows a user to pull the device and attached cooler along rough terrain with ease.

In one embodiment, the cooler utility cart device allows a single person to transport a large ice chest or cooler independently. Specifically, the cooler utility cart device allows users to fill the ice chest/cooler with food, beverages, ice, and other items and then strap it securely into the device for transport. Accordingly, the device maintains optimal stability of the secured ice chest/cooler as a user pulls the device along the ground. Further, the device offers a sleek and agile design that allows users to easily transport their ice chests/coolers to campsites, tailgate areas, lakes, ponds, pools, beaches, and numerous other outdoor areas.

In one embodiment, the cooler utility cart device is configured to retain a conventional cooler or ice chest. Specifically, the cooler and ice chest is a typical cooler and ice chest as is known in the art. Typically, the cooler and ice chest is a generally rectangular assembly that holds items to be cooled therein with a releasable enclosure lid member.

In one embodiment, the cooler utility cart device comprises a base component that has a squared back and bottom section, with triangular sides. The back and bottom sections and triangular sides form an open, interior cavity which is sized and shaped to accept a conventional ice chest or cooler. The base component is approximately 26 inches tall, 22 inches long and 24 inches wide, enabling the base component to transport up to a 165 quart ice chest over any terrain like dirt, gravel, sand, etc. Further, the base component can be available in a variety of sizes to accept various sizes of ice chests or coolers. Typically, the back and bottom sections and triangular sides are secured together via screws, pins, adhesives, tongue and groove, etc., or any suitable securing means as is known in the art.

In one embodiment, the cooler utility cart device comprises a set of pneumatic tires. Specifically, the support tire assembly includes a pair of spaced, parallel tires interconnected by a main support shaft. The support shaft is secured to an underside of the bottom section of the base component and rotatable via bearing members (not shown) in a conventional manner. The set of tires can be secured to the support shaft via any suitable securing means as is known in the art, such as bolts, screws, pins, etc. Further, any suitable tires can be utilized as is known in the art, but typically, the tires are rugged, all-terrain wheels which are approximately 2-10 inches in size and which help the device travel around the yard during use. Additionally, any suitable number of tires and any suitable size of tires can be utilized as is known in the art, depending on the needs and/or wants of a user. In one embodiment, the tires are castors, rollers, swivel wheels, etc. disposed on the underside of the bottom section of the base component and may allow the cooler utility cart device to roll in any direction. In other words, the tires may rotate, swivel, and pivot, based on a user's preferences and/or needs.

In one embodiment, the cooler utility cart device comprises a handle. The handle is telescopic and ergonomic and allows a user to pull the device and attached cooler along rough terrain with ease. Typically, the handle is secured to an underside of the bottom section of the base component to hold when moving the device from place to place. The handle is secured to the base component via any suitable securing means as is known in the art, such as welding, adhesives, mechanical fasteners, etc. Further, the handle can be any suitable handle as is known in the art, as long as the handle allows a user to securely and comfortably retain the device within their hand. Further, the length and diameter of the handle may vary widely, as it is important only that it be reasonably comfortable to hold by hand during use.

In one embodiment, the handle can comprise gripping texture areas or other suitable non-slip resistant areas to provide a non-slip grip for a user. Additionally, the handle can also be curved or rounded, or otherwise ergonomically shaped to allow the user to more easily pull the device, when in use. Further, in one embodiment, the handle comprises a handhold at its end that allows a user to grasp when pulling the device.

In one embodiment, the handle may be formed as a single, solid assembly. In another embodiment, the handle is telescoping, such that the handle can be extended and/or retracted, as needed. Further, the telescoping handle comprises at least one telescoping segment that allows the total length of the handle to be extended or retracted. Each telescoping segment is hollow and has a slip lock for locking the segment at a specific length. Further, the slip lock is released by means of pressing or turning the slip lock. The at least one telescoping segments allow the handle to have a length from approximately 2-3 feet fully extended, allowing a user to set the handle at a desired length. During operation, the handle may be extended during use and semi-collapsed back into its compacted form during nonuse and storage.

In one embodiment, the base component comprises a plurality of straps for securing the cooler within the device. Specifically, once a cooler is fitted within the base component, such that it contacts the squared back and bottom sections, straps can be used to secure the cooler into the base component. The straps can be independent and separate from the device. Once the cooler is positioned within the base component, the straps can be positioned around the cooler and device and then secured together, securing the cooler within the device for transport. In another embodiment, the straps are secured to the base component preventing removal of the straps. In this embodiment, once the cooler is in position within the base component, the straps are again positioned around the cooler and device and then secured together, securing the cooler within the device for transport. Any suitable number and size of straps can be utilized as is known in the art, depending on the needs and/or wants of a user.

In one embodiment, the cooler utility cart device comprises a prop component for stabilizing the cooler on the ground after transport. Specifically, the prop component is attached underneath the front of the cooler, allowing the cooler to be positioned parallel to the ground. The prop component is typically a rectangular base with a stem that removably secures to the underside of the front of the cooler or is just positioned on the underside of the cooler and not secured. Further, the base and stem allow the cooler to be positioned in a level position, parallel to the ground.

In operation, when the cooler or ice chest is positioned within the base component for transport, the cooler or ice chest is tilted rearwardly as shown in the figures and then pulled behind a user via the handle. Further, the straps act to further secure the cooler within the base component for transport over rough terrain.

In one embodiment, the cooler utility cart device is manufactured from wood, aluminum, or carbon fiber, or other suitable materials as is known in the art, or a combination of such materials.

In yet another embodiment, the cooler utility cart device comprises a plurality of indicia.

In yet another embodiment, a method of transporting a cooler via a single person is disclosed. The method includes the steps of providing a cooler utility cart device comprising a base component with wheels and a handle. The method also comprises positioning the cooler within the base component. Further, the method comprises strapping the cooler into the base component. The method also comprises pulling the device and cooler via the handle. Finally, the method comprises stabilizing the cooler via a prop component, such that the cooler is parallel to the device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cooler utility cart device of the present invention showing the device and its components in accordance with the disclosed architecture;

FIG. 2 illustrates a perspective view of one embodiment of the cooler utility cart device of the present invention showing the cooler positioned within the base component in accordance with the disclosed architecture;

FIG. 3 illustrates a perspective view of one embodiment of the cooler utility cart device of the present invention showing how the cooler is strapped into the base component in accordance with the disclosed architecture;

FIG. 4 illustrates a perspective view of one embodiment of the cooler utility cart device of the present invention showing a user pulling the cooler and device in accordance with the disclosed architecture;

FIG. 5 illustrates a perspective view of one embodiment of the cooler utility cart device of the present invention showing the cooler stabilized on the ground in accordance with the disclosed architecture; and

FIG. 6 illustrates a flowchart showing the method of transporting a cooler via a single person in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cooler utility cart device that provides users with a utility cart that helps a single person independently transport large and oversized ice chests and coolers. There is also a long felt need in the art for a cooler utility cart device that allows users to fill the chest with food, beverages, ice, and other items and then strap it securely into the cart for transport. Further, there is a long felt need in the art for a cooler utility cart device that utilizes a pair of pneumatic wheels that facilitate movement over gravel, dirt, sand, and any other type of uneven or rough terrain. Moreover, there is a long felt need in the art for a device that maintains optimal stability via the square backing and straps to keep the ice chest secure as a user pulls the cart along the ground. Further, there is a long felt need in the art for a cooler utility cart device that offers a sleek and agile design that allows people to easily transport their ice chests to campsites, tailgate areas, lakes, ponds, pools, beaches, and numerous other outdoor areas. Finally, there is a long felt need in the art for a cooler utility cart device that can be constructed of wood, aluminum, or carbon fiber.

The present invention, in one exemplary embodiment, is a novel cooler utility cart device. The cooler utility cart device comprises a base component that has a squared back section and triangular sides with a set of pneumatic tires and a handle. Once a cooler is fitted within the square backing, straps can be used to secure the cooler into the base component. The handle is telescopic and ergonomic and allows a user to pull the device and attached cooler along rough terrain with ease. Further, the cooler can be stabilized on the ground via placement of a prop component which attaches underneath the front of the cooler, allowing the cooler to be positioned parallel to the device. The present invention also includes a novel method of transporting a cooler via a single person. The method includes the steps of providing a cooler utility cart device comprising a base component with wheels and a handle. The method also comprises positioning the cooler within the base component. Further, the method comprises strapping the cooler into the base component. The method also comprises pulling the device and cooler via the handle. Finally, the method comprises stabilizing the cooler via a prop component, such that the cooler is parallel to the device.

Referring initially to the drawings, FIG. 1 illustrates a perspective view of one embodiment of the cooler utility cart device 100 of the present invention. In the present embodiment, the cooler utility cart device 100 is an improved cooler utility cart device 100 that provides a user with a utility cart capable of transporting a large ice chest or cooler via one person. Specifically, the cooler utility cart device 100 comprises a base component 102 with wheels 104 and a handle 106. Once a cooler 108 is fitted within the base component 102, straps 110 can be used to secure the cooler 108. The handle 106 allows a user 112 to pull the device 100 and attached cooler 108 along rough terrain with ease.

Generally, the cooler utility cart device 100 allows a single person to transport a large ice chest or cooler 108 independently. Specifically, the cooler utility cart device 100 allows users 112 to fill the ice chest/cooler 108 with food, beverages, ice, and other items and then strap it securely into the device 100 for transport. Accordingly, the device 100 maintains optimal stability of the secured ice chest/cooler 108 as a user 112 pulls the device 100 along the ground 114. Further, the device 100 offers a sleek and agile design that allows users 112 to easily transport their ice chests/coolers to campsites, tailgate areas, lakes, ponds, pools, beaches, and numerous other outdoor areas.

Further, the cooler utility cart device 100 comprises a base component 102 that has a squared back 116 and bottom section 118, with triangular sides 120. The back 116 and bottom 118 sections and triangular sides 120 form an open, interior cavity 122 which is sized and shaped to accept a conventional ice chest or cooler 108. The base component 102 is approximately 26 inches tall, 22 inches long and 24 inches wide, enabling the base component 102 to transport up to a 165 quart ice chest 108 over any terrain like dirt, gravel, sand, etc. Further, the base component 102 can be available in a variety of sizes to accept various sizes of ice chests or coolers 108. Typically, the back 116 and bottom 118 sections and triangular sides 120 are secured together via screws, pins, adhesives, tongue and groove, etc., or any suitable securing means as is known in the art.

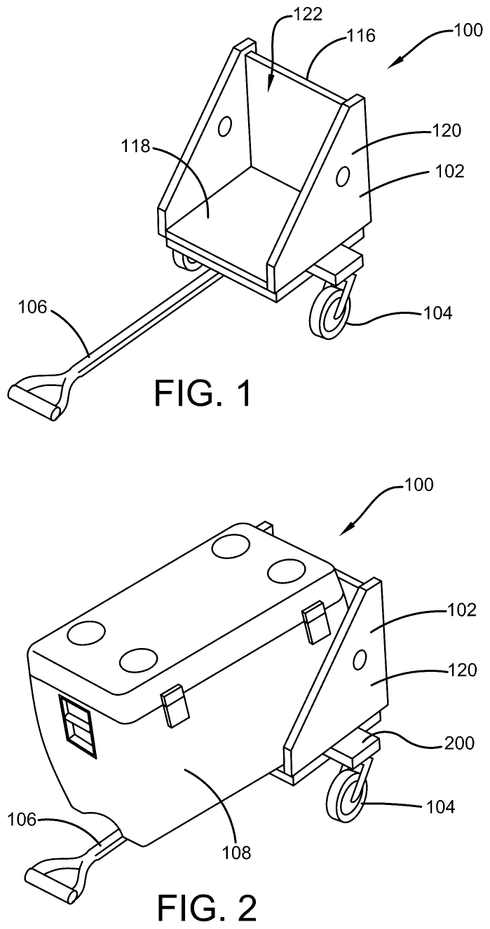

As shown in FIG. 2, the cooler utility cart device 100 is configured to retain a conventional cooler or ice chest 108. Specifically, the cooler and ice chest 108 is a typical cooler and ice chest as is known in the art. Typically, the cooler and ice chest 108 is a generally rectangular assembly that holds items to be cooled therein with a releasable enclosure lid member.

Further, the cooler utility cart device 100 comprises a set of pneumatic tires 104. Specifically, the support tire assembly includes a pair of spaced, parallel tires 104 interconnected by a main support shaft 200. The support shaft 200 is secured to an underside of the bottom section 118 of the base component 102 and rotatable via bearing members (not shown) in a conventional manner. The set of tires 104 can be secured to the support shaft 200 via any suitable securing means as is known in the art, such as bolts, screws, pins, etc. Further, any suitable tires 104 can be utilized as is known in the art, but typically, the tires 104 are rugged, all-terrain wheels which are approximately 2-10 inches in size and which help the device 100 travel around the yard during use. Additionally, any suitable number of tires 104 and any suitable size of tires 104 can be utilized as is known in the art, depending on the needs and/or wants of a user 112. In one embodiment, the tires 104 are castors, rollers, swivel wheels, etc. disposed on the underside of the bottom section 118 of the base component 102 and may allow the cooler utility cart device 100 to roll in any direction. In other words, the tires 104 may rotate, swivel, and pivot, based on a user's preferences and/or needs.

Additionally, the cooler utility cart device 100 comprises a handle 106. The handle 106 is telescopic and ergonomic and allows a user 112 to pull the device 100 and attached cooler 108 along rough terrain with ease. Typically, the handle 106 is secured to an underside of the bottom section 118 of the base component 102 to hold when moving the device 102 from place to place. The handle 106 is secured to the base component 102 via any suitable securing means as is known in the art, such as welding, adhesives, mechanical fasteners, etc. Further, the handle 106 can be any suitable handle as is known in the art, as long as the handle 106 allows a user 112 to securely and comfortably retain the device 100 within their hand. Further, the length and diameter of the handle 106 may vary widely, as it is important only that it be reasonably comfortable to hold by hand during use.

In one embodiment, the handle 106 can comprise gripping texture areas 202 or other suitable non-slip resistant areas to provide a non-slip grip for a user 112. Additionally, the handle 106 can also be curved or rounded, or otherwise ergonomically shaped to allow the user 112 to more easily pull the device 100, when in use. Further, in one embodiment, the handle 106 comprises a handhold 204 at its end that allows a user 112 to grasp when pulling the device 100.

In another embodiment, the handle 106 may be formed as a single, solid assembly. In yet another embodiment, the handle 106 is telescoping, such that the handle 106 can be extended and/or retracted, as needed. Further, the telescoping handle comprises at least one telescoping segment 206 that allows the total length of the handle 106 to be extended or retracted. Each telescoping segment 206 is hollow and has a slip lock 208 for locking the segment 206 at a specific length. Further, the slip lock 208 is released by means of pressing or turning the slip lock 208. The at least one telescoping segments 206 allow the handle 106 to have a length from approximately 2-3 feet fully extended, allowing a user 112 to set the handle 106 at a desired length. During operation, the handle 106 may be extended during use and semi-collapsed back into its compacted form during nonuse and storage.

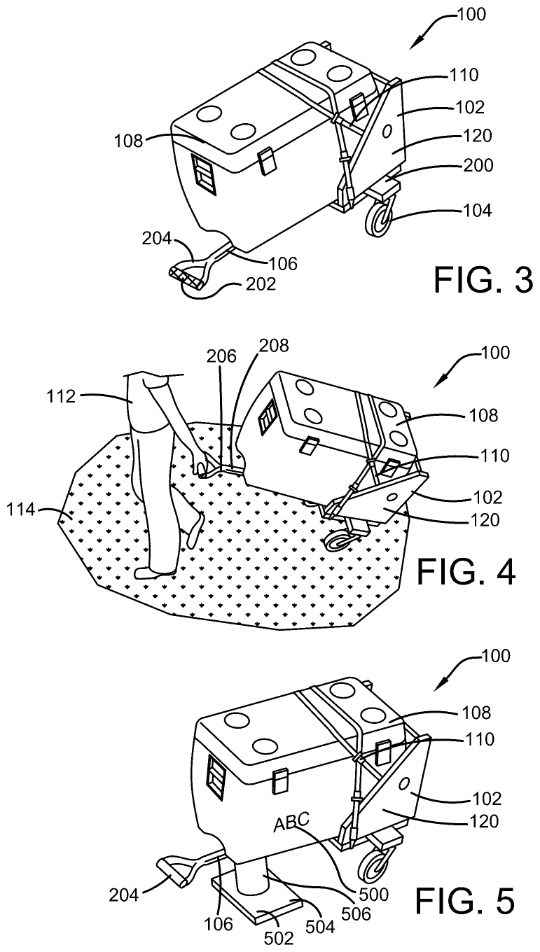

As shown in FIG. 3, the base component 102 comprises a plurality of straps 110 for securing the cooler 108 within the device 100. Specifically, once a cooler 108 is fitted within the base component 102, such that it contacts the squared back 116 and bottom 118 sections, straps 110 can be used to secure the cooler 108 into the base component 102. The straps 110 can be independent and separate from the device 100. Once the cooler 108 is positioned within the base component 102, the straps 110 can be positioned around the cooler 108 and device 100 and then secured together, securing the cooler 108 within the device 100 for transport. In another embodiment, the straps 110 are secured to the base component 102 preventing removal of the straps 110. In this embodiment, once the cooler 108 is in position within the base component 102, the straps 110 are again positioned around the cooler 108 and device 100 and then secured together, securing the cooler 108 within the device 100 for transport. Any suitable number and size of straps 110 can be utilized as is known in the art, depending on the needs and/or wants of a user 112.

As shown in FIG. 4, in operation, when the cooler or ice chest 108 is positioned within the base component 102 for transport, the cooler or ice chest 108 is tilted rearwardly as shown in the figures and then pulled behind a user 112 via the handle 106. Further, the straps 110 act to further secure the cooler 108 within the base component 102 for transport over rough terrain.

Typically, the cooler utility cart device 100 is manufactured from wood, aluminum, or carbon fiber, or other suitable materials as is known in the art, or a combination of such materials.

In one embodiment, the cooler utility cart device 100 comprises a prop component 502 for stabilizing the cooler 108 on the ground 114 after transport. Specifically, the prop component 502 is attached underneath the front of the cooler 108, allowing the cooler 108 to be positioned parallel to the ground 114. The prop component 502 is typically a rectangular base 504 with a stem 506 that removably secures to the underside of the front of the cooler 108 or is just positioned on the underside of the cooler 108 and not secured. Further, the base 504 and stem 506 allow the cooler 108 to be positioned in a level position, parallel to the ground 114.

In yet another embodiment, the cooler utility cart device 100 comprises a plurality of indicia 500. The base component 102 of the device 100 may include advertising, a trademark, or other letters, designs, or characters, printed, painted, stamped, or integrated into the base component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be cooler, ice chest, or brand related.

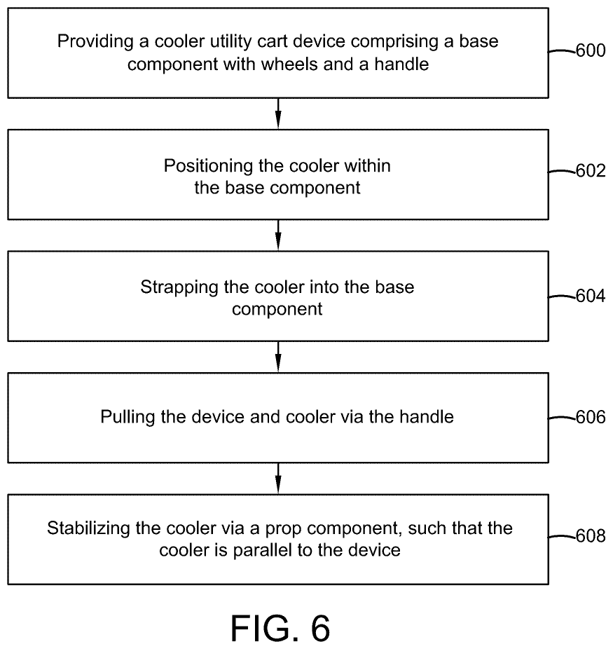

FIG. 6 illustrates a flowchart of the method of transporting a cooler via a single person. The method includes the steps of at 600, providing a cooler utility cart device comprising a base component with wheels and a handle. The method also comprises at 602, positioning the cooler within the base component. Further, the method comprises at 604, strapping the cooler into the base component. The method also comprises at 606, pulling the device and cooler via the handle. Finally, the method comprises at 608, stabilizing the cooler via a prop component, such that the cooler is parallel to the device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cooler utility cart device”, “utility cart device”, “cooler device”, and “device” are interchangeable and refer to the cooler utility cart device 100 of the present invention.

Notwithstanding the forgoing, the cooler utility cart device 100 of the present invention can be of any suitable size and configuration as is known in the art without affecting the overall concept of the invention, provided that it accomplishes the above stated objectives. One of ordinary skill in the art will appreciate that the cooler utility cart device 100 as shown in FIGS. 1-6 is for illustrative purposes only, and that many other sizes and shapes of the cooler utility cart device 100 are well within the scope of the present disclosure. Although the dimensions of the cooler utility cart device 100 are important design parameters for user convenience, the cooler utility cart device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cooler utility cart device that provides a user with a stool manipulated solely by a handle, the cooler utility cart device comprising:
a base component;
a pair of tires; and
a handle; and
wherein the handle and the pair of tires are secured to the base component;
wherein the base component is sized and shaped to retain a cooler; and
further wherein the handle allows a user to pull the base component and attached cooler along rough terrain with ease.

2. The cooler utility cart device of claim 1, wherein the base component has a squared back and bottom section, with triangular sides.

3. The cooler utility cart device of claim 2, wherein the back and bottom sections and triangular sides form an open, interior cavity which is sized and shaped to accept a conventional ice chest or cooler.

4. The cooler utility cart device of claim 3, wherein the base component is approximately 26 inches tall, 22 inches long and 24 inches wide, enabling the base component to transport up to a 165 quart ice chest over rough terrain.

5. The cooler utility cart device of claim 4, wherein the base component is available in a variety of sizes to accept various sizes of ice chests or coolers.

6. The cooler utility cart device of claim 5, wherein the pair of tires are spaced apart and interconnected by a main support shaft.

7. The cooler utility cart device of claim 6, wherein the support shaft is secured to an underside of the bottom section of the base component.

8. The cooler utility cart device of claim 7, wherein the tires are rugged, all-terrain wheels which are approximately 2-10 inches in size and which help the cooler utility cart device travel around rough terrain during use.

9. The cooler utility cart device of claim 8, wherein the handle is secured to an underside of the bottom section of the base component to hold when moving the cooler utility cart device from place to place.

10. The cooler utility cart device of claim 9, wherein the handle comprises a gripping texture area.

11. The cooler utility cart device of claim 10, wherein the handle comprises a handhold at its end that allows a user to grasp when pulling the cooler utility cart device.

12. The cooler utility cart device of claim 11, wherein the handle is formed as a single, solid assembly.

13. The cooler utility cart device of claim 11, wherein the handle is telescoping, such that the handle can be extended or retracted, as needed.

14. The cooler utility cart device of claim 13, wherein the base component comprises a plurality of straps for securing the cooler within the base component.

15. The cooler utility cart device of claim 14, wherein a prop component is attached underneath a front of the cooler, allowing the cooler to be positioned in a level position, parallel to the ground.

16. A cooler utility cart device that provides a user with a stool manipulated solely by a handle, the cooler utility cart device comprising:
a base component with a squared back and bottom section, and with triangular sides;
a pair of tires spaced apart and interconnected by a main support shaft; and
a handle which has a gripping section and is telescoping; and
wherein the handle is secured to an underside of the bottom section of the base component to hold when moving the cooler utility cart device from place to place;
wherein the handle comprises a handhold at its end that allows a user to grasp when pulling the cooler utility cart device;
wherein the back and bottom sections and triangular sides form an open, interior cavity which is sized and shaped to retain a cooler;
wherein the support shaft and the pair of tires are secured to an underside of the bottom section of the base component;
wherein the base component comprises a plurality of straps for securing the cooler within the base component;
wherein a prop component is attached underneath a front of the cooler, allowing the cooler to be positioned in a level position, parallel to the ground;
wherein the cooler is tilted rearwardly and then pulled behind a user via the handle; and
further wherein the handle allows a user to pull the base component and attached cooler along rough terrain with ease.

17. The cooler utility cart device of claim 16, wherein the cooler utility cart device is manufactured from wood, aluminum, or carbon fiber.

18. The cooler utility cart device of claim 16, wherein the prop component comprises a rectangular base with a stem that removably secures to an underside of the front of the cooler, to allow the cooler to be positioned in a level position, parallel to the ground.

19. The cooler utility cart device of claim 16 further comprising a plurality of indicia.

20. A method of transporting a cooler via a single person, the method comprising the following steps:
providing a cooler utility cart device comprising a base component with wheels and a handle;
positioning the cooler within the base component;
strapping the cooler into the base component;
pulling the device and cooler via the handle; and
stabilizing the cooler via a prop component, such that the cooler is parallel to the device.
